(19) United States
(12) Patent Application Publication
(10) Pub. No.: US 2008/0017042 A1
(43) Pub. Date: Jan. 24, 2008

(54) Automated coffee brewing and dispensing apparatus

(76) Inventors: Robert Almblad, Dunedin, FL (US); Jay M. Almblad, Mundelein, IL (US)

Correspondence Address: ARTHUR W. FISHER, III, #316, 5553 West Waters Ave, Tampa, FL, 33634, US

(21) Appl. No.: 11/879,105

(22) Filed: Jul. 16, 2007

Related U.S. Application Data
(60) Provisional application No. 60/831,875, filed on Jul. 19, 2006.
(60) Provisional application No. 60/922,876, filed on Apr. 11, 2007.

(51) Int. Cl. A47J 31/02; A47J 31/44

(52) U.S. Cl. 99/280

(57) ABSTRACT

An automated coffee brewing and dispensing apparatus capable of selectively brewing a batch of coffee on demand and selectively dispensing coffee into containers on demand comprising a coffee brewing station (18) to brew and store the brewed coffee, a remote coffee dispensing station (40) to dispense brewed coffee received from the brewing station, a circulation system (41/43/46/48/50/52/54) to circulate brewed coffee between the coffee brewing station (18) and the coffee dispensing station (40) and a system control processor (42) to control the brewing, circulating and dispensing of the coffee by the automated coffee brewing and dispensing apparatus.

### CROSS REFERENCE

This application claims priority based upon provisional application Ser. No. 60/831,875 filed Jul. 19, 2006 and provisional application Ser. No. 60/922,876 filed Apr. 11, 2007.

### BACKGROUND OF THE INVENTION

1. Field of the Invention

An automated coffee brewing and dispensing apparatus capable of delivering fresh hot coffee to a remote site.

2. Description of the Prior Art

Commercially, such as in a restaurant, coffee is served hot and can accidentally spill when poured from a handheld pot. Generally, a free standing coffee machine with a stationary dispensing spout is safer to fill coffee cups. However, such coffee machines are large and cannot be used in many locations such as the drive-through window area found in quick serve restaurants (QSR). Moreover, it is expensive to place multiple machines where coffee is served.

At most restaurants coffee is brewed by passing 200 degree water through coffee grounds retained in a brew basket. This process generally takes from about 3 to 5 minutes. To maintain freshness, the brewed coffee can be held for 20 minutes in an open pot or for about 60 minutes in a closed pot. To preserve the freshness of brewed coffee, most QSRs will throw out the coffee and make another batch to maintain fresh brewed coffee. As a result, a great amount of coffee is wasted each day.

Another reason to brew coffee in batches is the demand for additional amounts of brewed coffee. This requires wait-staff to stop what they are doing to brew fresh coffee occurring during rush hour and when QSR lines and backed-up. Therefore, there is a need to have a coffee machine to automatically brew coffee in a timely demand driven fashion.

Thus, there is a need for an automated coffee and dispensing system capable of delivering fresh hot coffee in a timely fashion.

### SUMMARY OF THE INVENTION

The present invention relates to an automated coffee brewing and dispensing apparatus comprising a coffee brewing station and at least one coffee dispensing station coupled together by a circulating system to transfer brewed coffee therebetween in combination with a system control or microprocessor to control the brewing, circulating and dispensing of coffee by the automated coffee brewing and dispensing apparatus.

The coffee brewing station comprises a cabinet or tower including a lower base to support the coffee brewing station on a support surface and an upper brew basket support or housing to removably support a brew basket and a water heater held in spaced relation relative thereto, an intermediate heated coffee make-up tank disposed beneath the brew basket to receive brewed coffee therefrom and a lower heated brewed coffee supply tank disposed beneath the intermediate coffee make-up tank to selectively receive a batch of brewed coffee therefrom.

The circulation system comprises a continuous flow closed loop brewed coffee circulation path or recirculation system between the lower heated brewed coffee supply tank, a circulator pump, and the brewed coffee dispensing station to increase the shelf life of the brewed coffee.

The system control processor is programmed to fulfill the requirements of any specific automated coffee brewing and dispensing apparatus to purge stale or “old” coffee and brew batches of coffee to maintain inventory to meet quantity demands.

The circulation system can include circulation conduit insulation and circulation conduit heat source to maintain the brewed coffee at a predetermined temperature such as from about 175 degrees to about 185 degrees as the brewed coffee is circulated through the circulation system.

The timing and sequencing of the automated coffee brewing and dispensing apparatus is programmed or controlled by the system controller or processor.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a side view of a pot of freshly brewed coffee on a hot plate or heat source.

FIG. 2 is a side view of a pot of coffee after the solid particles begin to settle to the bottom of the pot on a hot plate or heat source.

FIG. 3 is a perspective view of the coffee brewing station of the present invention.

FIG. 4 is a partial side view of the coffee brewing station of the present invention.

FIG. 5 is a schematic of the automated coffee brewing apparatus of the present invention.

FIG. 6 is a partial exploded view of a coffee dispensing station of the present invention.

FIG. 7 is a front view of an alternate embodiment of a coffee dispensing station of the present invention.

FIG. 8 is a rear view of the alternate embodiment of the coffee dispensing station of the present invention as shown in FIG. 7.

FIG. 9 is a perspective view of an alternate embodiment of the coffee brewing station of the present invention.

FIG. 10 is a partial perspective view of the upper brew basket of the alternate embodiment of the coffee brewing station of the present invention as shown in FIG. 9.

FIG. 11 is a perspective view of the upper brew basket of the alternate embodiment of the coffee brewing station of the present invention as shown in FIG. 9.

Similar reference characters refer to similar parts throughout the several views of the drawings.

### DETAILED DESCRIPTION OF THE PREFERRED EMBODIMENT

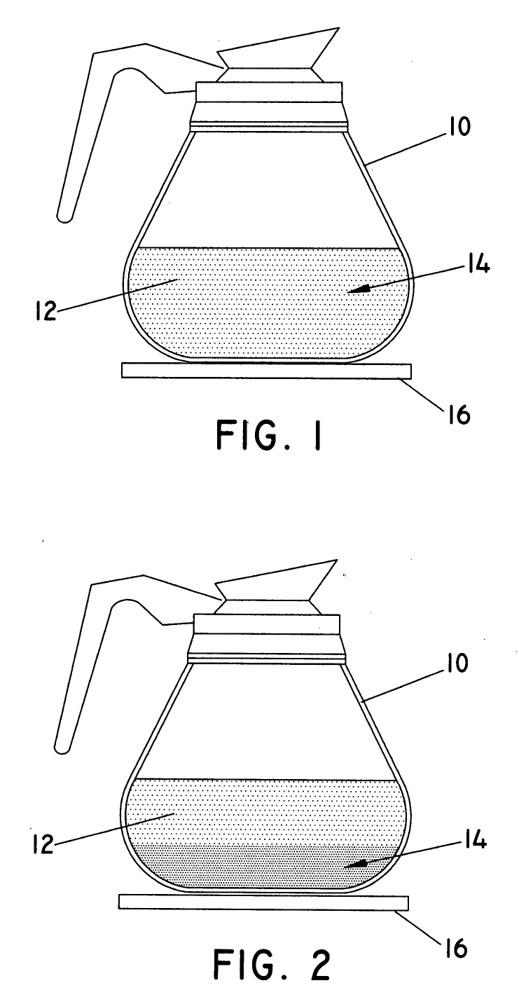

FIG. 1 shows a container 10 of brewed coffee 12 with particles 14 uniformly suspended in the liquid. The container 10 is placed on a hot plate 16 or other heat source to maintain the coffee 12 from about 175 degrees to about 185 degrees. Over time, as the hotter coffee rises and cooler coffee falls within the container 10 through convection, the particles 14 accumulate in the bottom of the container 10 as shown in FIG. 2. As a result, the quality or taste of the brewed coffee 12 deteriorates.

A centrally located coffee brewing station can make batches of coffee automatically to keep pace with a restaurant's need for coffee. At the same time the coffee brewing station can maintain a fresh batch of coffee by purging old coffee and automatically brewing new coffee on demand.

Specifically, the coffee brewing station brews a fresh batch of coffee either when the coffee in inventory is too old or when the quantity of coffee is too low and a new batch of coffee is required to meet the need for coffee.

The brewed coffee is circulated from the central location to one or more remote locations such as the drive-through window or the front counter of a restaurant or the self serve area. The brewed coffee can be circulated from and returned to the automated coffee apparatus reservoir through a continuous closed loop circulation system so the coffee is always hot and “in motion”. There are one or more “taps” or dispensing stations along this recirculating line of coffee, where hot coffee can be dispensed. In addition, there can be heating elements and insulation surrounding the circulation conduits for insulating the coffee to maintain a predetermined temperature such as about 180 degrees F. The coffee reservoir or storage can also include a heat source.

An advantage of recirculating the brewed coffee is that a central location can service multiple locations, especially where space is scarce such as the drive-thru, effectively extending the life of the coffee by keeping coffee particulates and solids in suspension, and preventing them from settling on the bottom of the pot and burning. The user interface can be either be a POS system for the wait-staff at a restaurant, or a self-serve kiosk-user interface that customers use to order and make their own custom coffee drink or other drink, like tea, that might also be connected to the termination delivery dispensing point. In any case, the POS and/or the kiosk can be directly connected to the automated coffee machine/system so that the order is fulfilled based on information from the POS or kiosk.

As described more fully hereinafter, the present invention comprises a coffee brewing station and at least one coffee dispensing station coupled together by a circulating system to transfer brewed coffee therebetween in combination with a system control or microprocessor to control the brewing, circulating and dispensing of coffee by the automated coffee brewing and dispensing apparatus.

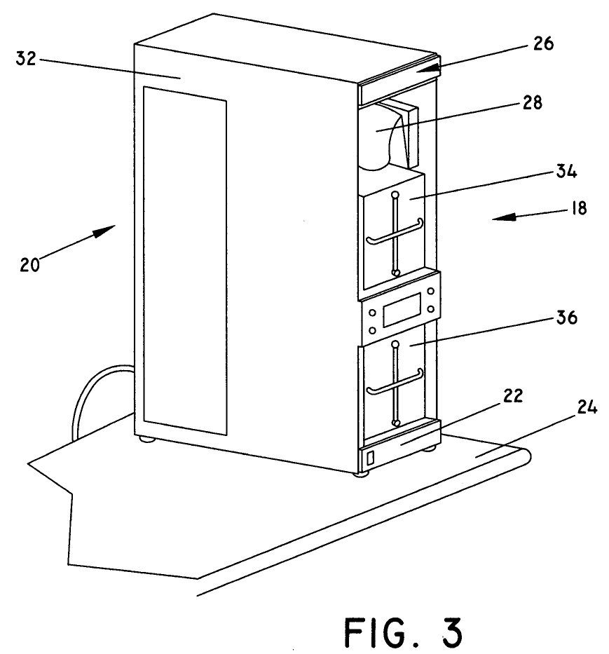

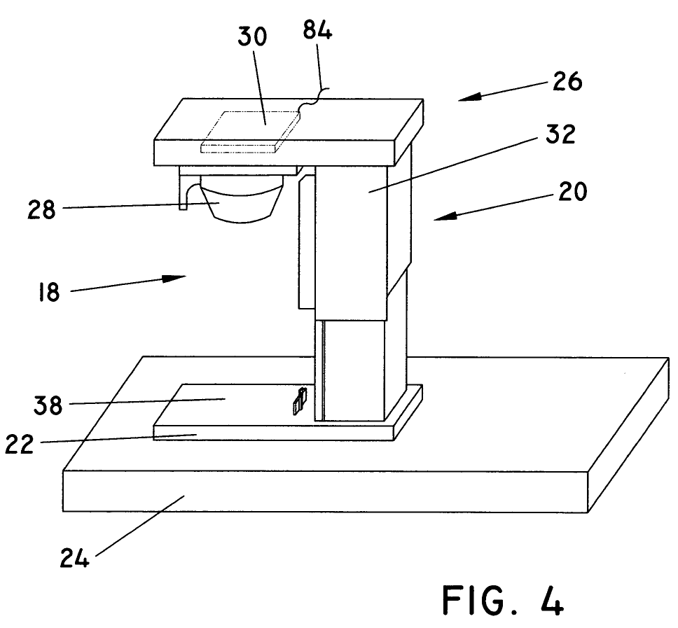

As shown in FIGS. 3 and 4, the coffee brewing station generally indicated as 18 comprises a cabinet or tower generally indicated as 20 including a lower base 22 to support the coffee brewing station 18 on a support surface 24 and an upper brew basket support or housing 26 to removably support a brew basket 28 and a water heater 30 held in spaced relation relative thereto by a substantially vertical hollow support column 32, an intermediate heated coffee make-up tank 34 mounted to the substantially vertical hollow support column 32 beneath the brew basket 28 to receive brewed coffee therefrom and a lower heated brewed coffee supply tank 36 supported or resting on the upper surface 38 of the lower base 32 beneath the intermediate coffee make-up tank 34 to selectively receive a batch of brewed coffee consisting of substantially the entire contents of brewed coffee therefrom.

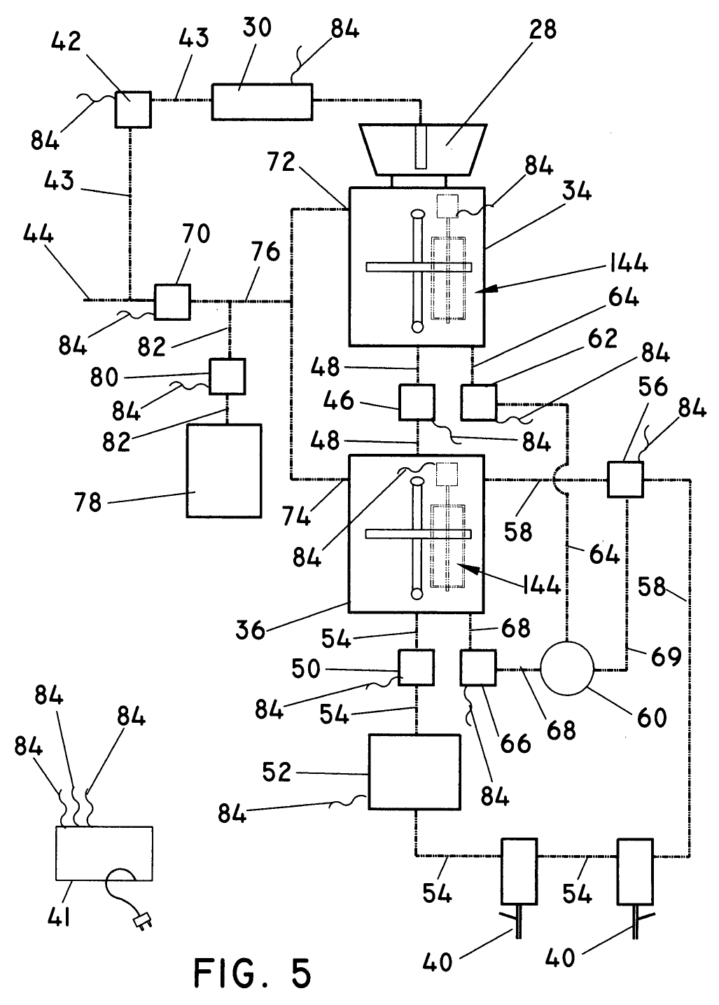

FIG. 5 best shows the liquid circulating system in operative relationship relative to the coffee brewing station 18, a plurality of coffee dispensing stations each generally indicated as 40 and the system control processor 42.

A water heater valve 41 and a water supply conduct 43 are coupled between a water supply 44 and the water heater 30 of the upper brew basket support or housing 26 to selectively feed or supply water to coffee grounds retained in the coffee brew basket 28 for brewing, a batch transfer valve 46 and a batch brewed coffee conduit 48 coupled between the intermediate heated coffee make-up tank 34 and lower heated coffee supply tank 36 to selective feed or supply brewed coffee to the lower heated coffee supply tank 36 on demand and a brewed coffee outlet valve 50, a circulation pump 52 and a brewed coffee outlet conduit 54 coupled between the lower heated coffee supply tank 36 and the dispensing station 40 to selectively feed brewed coffee thereto on demand. The circulating system further includes a brewed coffee recirculation return valve 56 and a brewed coffee recirculation return conduit 58 coupled between the dispensing station 40 and the upper portion of the lower heated brewed coffee supply or retention tank 36 to return undispensed brewed coffee to the brewed coffee supply or storage tank or reservoir 36 to provide a continuous flow closed loop brewed coffee circulation path or recirculation system between the lower heated brewed coffee supply tank 36, the circulator pump 52, the brewed coffee outlet conduit 54, the brewed coffee dispensing station 40, the brewed coffee recirculation return valve 56 and the brewed coffee recirculation return conduit 58 to increase the shelf life of the brewed coffee.

The circulation system can also include a tank drain subsystem and a tank cleaning subsystem. Specifically, a drain 60 is coupled to the intermediate heated coffee make-up tank 34 by a first drain valve 62 and a first drain conduit 64 and to the lower heated brewed coffee supply tank 36 by a second drain valve 66 and a second drain conduit 68 to drain the interior of the intermediate heated brewed coffee make-up tank 34 and lower heated coffee supply tank 36 of liquids. Brewed coffee can also be selectively drained from the dispensing station 40 through the brewed coffee recirculation return valve 56, the first leg or element of the brewed coffee recirculation return conduit 58 and a return drain conduit 69 to the drain 60.

Further, the interior of the intermediate heated coffee make-up tank 34 and lower heated brewed coffee supply tank 36 can be sanitized or cleaned by a cleaning circulation subsystem comprising a tank cleaning valve 70 coupled between the water supply 44 and a first cleaning nozzle 72 and a second cleaning nozzle 74 by a cleaning conduit 76 coupled to the intermediate heated coffee make-up tank 34 and the lower heated coffee supply tank 36 to spray a cleaning or sanitizing solution from a sanitizer supply container 78 coupled to the cleaning conduit 76 by a sanitizer supply valve 80 and a sanitizer conduit 82. The sanitizer is drawn from the sanitizer supply container 78 through venturi action.

Each of the valves 41, 46, 50, 56, 62, 66, 70 and 80 are selectively activated or operated between an open and closed or first and second position controlled by a solenoid or similar device (not shown) to selectively control the liquid flow through each valve and corresponding conduit(s). The valves (solenoids) are coupled to the system control processor 42 by corresponding lines or conductors each indicated as 84 to control the operation of the valves. The system control processor 42 is in turn coupled to a power source (not shown).

The system control processor 42 is programmed to fulfill the requirements of any specific automated coffee brewing and dispensing apparatus to purge stale or “old” coffee and brew batches of coffee to maintain inventory to meet quantity demands.

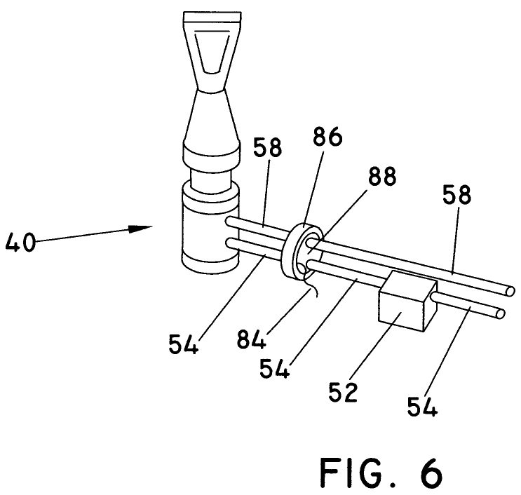

The circulation system can include circulation conduit insulation and circulation conduit heat source to maintain the brewed coffee at a predetermined temperature such as from about 175 degrees to about 185 degrees as the brewed coffee is circulated through the circulation system. Specifically, as shown in FIG. 6, insulation 86 can be placed in surrounding relationship relative to all or a portion of the brewed coffee outlet conduit 54 and the brewed coffee recirculation return conduit 58. In addition, a conduit heat source 88 can be coupled to a power source (not shown) or the system control or microprocessor 40 and disposed in heat transfer relation relative to the brewed coffee outlet conduit 54 and brewed coffee recirculation return valve 56 within the insulation 86. The conduit heat source 88 may be disposed adjacent the coffee dispensing station 20 or elsewhere along the circulation path. Of course, a plurality of conduit heat sources 88 can be distributed along the circulation path of the brewed coffee outlet conduit 54 and the brewed coffee recirculation return conduit 58.

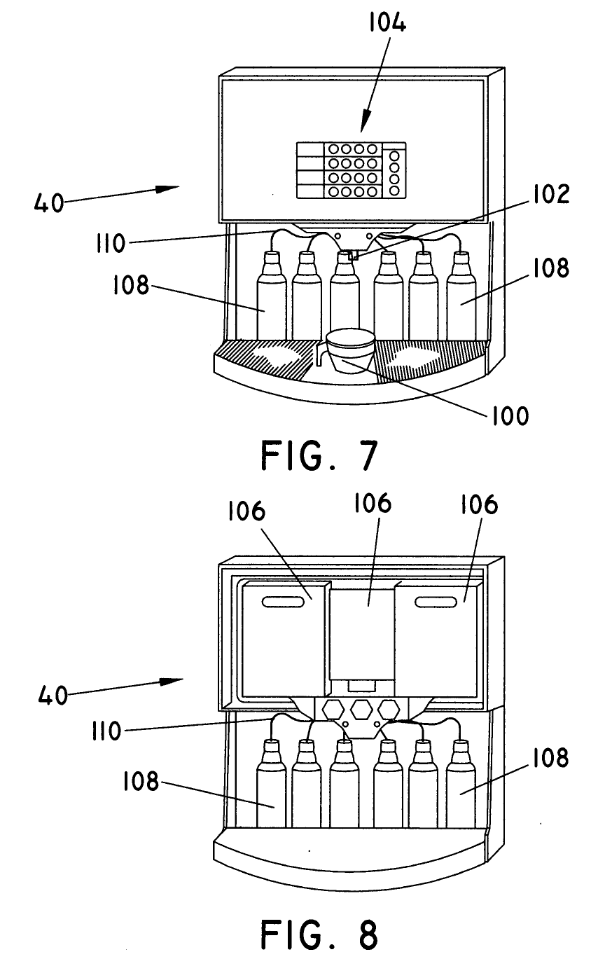

FIGS. 7 and 8 show a coffee dispensing station 40 capable of dispensing cups of coffee. The wait-staff or self-serve customer places a cup 100 under the single delivery point or dispensing nozzle 102 and selects the type and size of coffee and additive by the control panel generally indicated as 104. In particular, the operator selects the size of drink, type of drink such as regular coffee, decaffeinated coffee, tea, smoothie, ice coffee, or ice cappuccino and the amount of additional ingredient such as single, double, triple amounts of cream, milk, vanilla shot, sugar, artificial sweetener contained in compartments 106 or containers 108 that feed ingredients or product to nozzle 102 through supply conduits 110. Once selected, the ingredient(s) are automatically dispensed into the cup 100. The operator can repeat the last two steps to select another ingredient, the amount of that ingredient and so on until all ingredients are selected, each selected ingredient(s) automatically put into the cup (not shown)

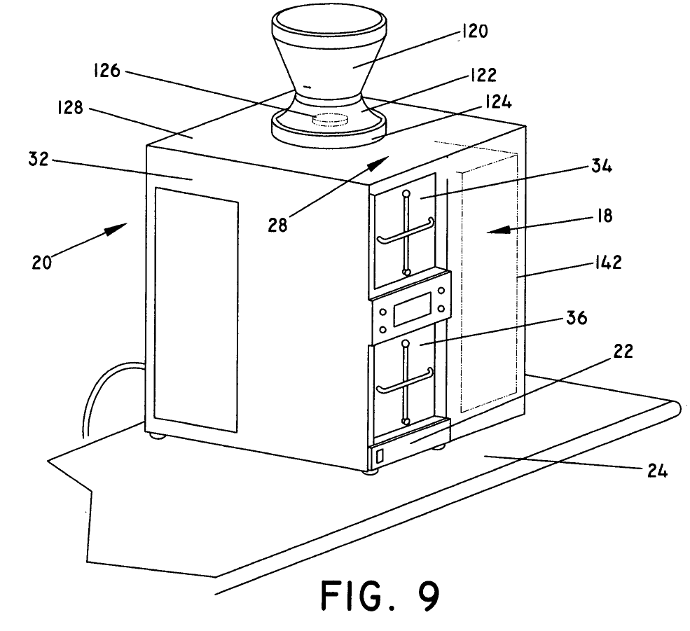

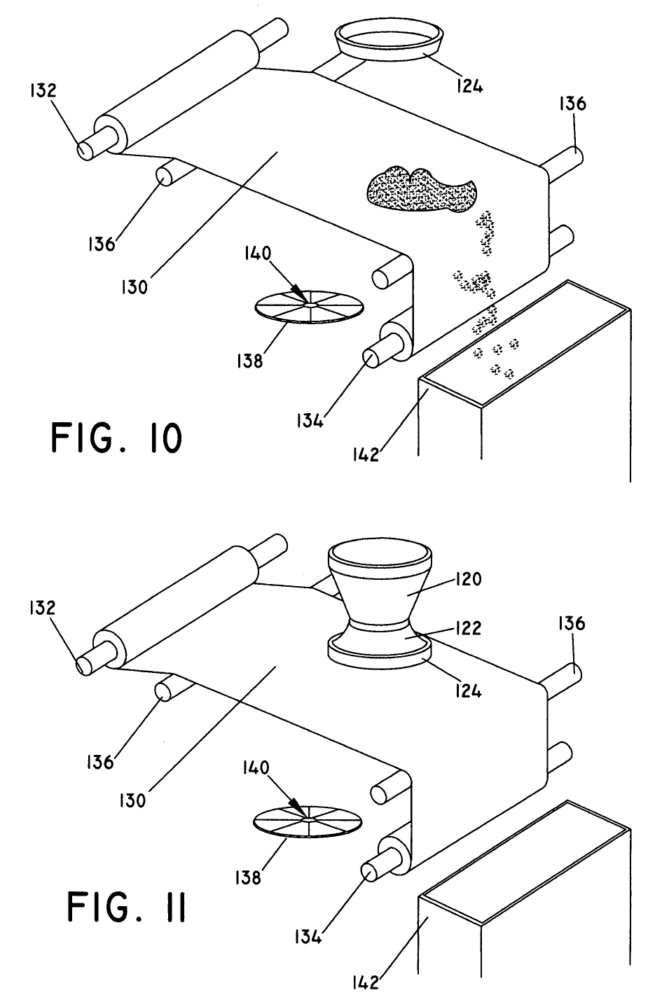

FIGS. 9 through 11 show an alternate embodiment of the automated coffee brewing and dispensing apparatus comprising an automated coffee brewing section including a coffee grounds supply and brew basket filter mechanism. Specifically, the coffee grounds supply and filter mechanism comprises a coffee bean bin 120 mounted to a coffee bean grinder 122 disposed above a coffee grounds retainer ring 124 mounted over an aperture 126 formed through the top 128 of the cabinet or tower 20. Disposed beneath the aperture 126, the brew basket filter mechanism comprises a coffee filter supply including filter paper 130 mounted on a filter paper supply shaft 132 and extending to a used filter paper take-up shaft 134 coupled to motors (not shown) to selective position unused filter paper beneath the aperture 126 to receive brewed coffee from the grounds retainer ring 124 when hot water from the water heater 30 is supplied to the interior thereof. A pair of brew basket rollers each indicated as 136 and a coffee basket member 138 including flow aperture 140 are movable disposed beneath the filter paper 130 extending between the filter paper supply shaft 132 and the used filter paper take-up shaft 134 into a waste coffee grounds compartment 142.

The coffee grounds retainer ring 124, filter paper 130 and coffee basket member 138 cooperatively form the brew basket 28.

The coffee basket member 138 selectively moves upward in unison with a pair of brew basket rollers 136 sealing the filter paper 130 between the coffee basket member and the coffee grounds retainer ring 124.

The coffee bean grinder 122 grinds the appropriate amount of coffee beans into the grounds retainer ring 124. Hot water is then injected to brew the coffee. When the brewing is complete, the automated coffee brewing and dispensing apparatus enters a clean in place mode where the freshly brewed coffee feeds to intermediate heated coffee make-up tank 34 to the lower heated brewed coffee supply tank 36 for circulation to the remote dispensing station(s) 40.

Next, the coffee basket member 138 and pair of brew basket roller 136 move downward exposing the used coffee grounds so that the filter paper 130 translates or moves horizontally by rotating the used filter paper take-up shaft 134. This causes the spent coffee grounds to fall off the edge into the waste coffee grounds compartment 142 below. This process disposes of most of the coffee grounds. But, the edges of the grounds retainer ring 124 may still have some coffee grounds. So, the coffee basket member 138 can be moved up to seal the grounds retainer ring 124 and a spray of hot water is directed at the walls of the grounds retainer ring 124. Then the coffee basket member 138 moves down again and the filter paper 130 is advanced enough to get a clean new filter paper 130 under the grounds retainer ring 124. The coffee basket member 138 moves up again to seal against the grounds retainer ring 124.

At this point, the intermediate heated coffee make-up tank 34 goes through a cleaning cycle. Once complete, the automated coffee brewing and dispensing apparatus is ready to brew another batch of coffee on demand.

In use, the automated coffee brewing and dispensing apparatus automatically brews coffee by feeding 200 degree water through the brew basket 28 falling and falls by gravity into the intermediate heated coffee make-up coffee make-up tank 34 disposed above the lower heated brewed coffee supply tank 36. Once the brewing cycle is complete, the batch transfer valve 46 automatically opens allowing the coffee in intermediate heated coffee make-up tank 34 to fall by gravity into lower heated brewed coffee supply tank 36. Once this is complete, the batch transfer valve 46 closes and the drain valve 62 in intermediate heated coffee make-up tank 34 opens and a sprayer in intermediate heated coffee make-up tank 34 is engaged to spray down the insides of intermediate heated coffee make-up tank 34. Once this is complete, the operator is notified that the coffee grounds need to be changed. Once the grounds are changed, the automated coffee brewing and dispensing apparatus is ready to brew another batch of coffee in the intermediate heated coffee make-up tank 34.

Now that lower heated brewed coffee supply tank 36 is full, the coffee can be dispensed.

The only action the operator needs to do is empty the grounds and place a new filter and new coffee for a fresh batch of coffee brewed when the next batch of coffee is required.

Both intermediate heated coffee make-up tank 34 and lower heated brewed coffee supply tank 36 have a heat source to maintain heat at a predetermined temperature such as of about 165 degrees to about 180 degrees.

A mixer generally indicated as 144 can be disposed in either intermediate heated coffee make-up tank 34 or the lower heated brewed coffee supply tank 36 to stir the coffee and maintain the heat at a predetermined temperature. In addition, the lower heated brewed coffee supply tank 36 is connected to the recirculating conduit 58 to agitate the contents thereof. Consequently, solids and particulates are in constant motion through the use of a recirculating line or a stirring mechanism to keep the particles off the bottom and in constant suspension.

There are at least four ways to adjust the time when the next batch of coffee is brewed. For example, manually, by time of day, by the level of the coffee or by the age of the coffee. This is done with the electronic controls of the system control processor 42 that automatically start up and shut down the automated coffee brewing and dispensing apparatus.

By time of day would depend on the history of the demand for coffee. So, in the busy time from 8 to 10 AM, the operator might set-up to brew a new pot of coffee in intermediate heated coffee make-up tank 34 as soon as lower heated brewed coffee supply tank 36 is 80% full. In a non-busy time between 2 PM and 10 PM, the operator might instruct the system control processor 42 to start a new batch of coffee when the lower heated brewed coffee supply tank 36 is 20% full.

By the age of the coffee the operator might set a limit of 1-3 hours. So at say 1 hour, the new batch is made in intermediate heated coffee make-up tank 34 and then at one hour and 10 minutes the balance in lower heated brewed coffee supply tank 36 is purged into the drain 60 and the fresh batch in intermediate heated coffee make-up tank 34 is fed by gravity from intermediate heated coffee make-up tank 34 into the lower heated brewed coffee supply tank 36.

When lower heated brewed coffee supply tank 36 is purged, the valve 66 is opened to the drain 60 and a sprayer is activated to wash down the walls and bottom of the lower heated brewed coffee supply tank 36 in preparation to receive the fresh batch from intermediate heated coffee make-up tank 34.

At the end of the day, the whole system can be cleaned-in-place (CIP). A CIP system is where a coffee cycle is run, as if there are new coffee grounds, but in fact there are no coffee grounds and so everything is cleaned by pumping and spraying all the intermediate heated coffee make-up tank 34 and the lower heated brewed coffee supply tank 36 and pumps with water and an optional cleaning solution.

The timing and sequencing of the automated coffee brewing and dispensing apparatus is programmed and controlled by the system controller or processor 42.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. An automated coffee brewing and dispensing apparatus capable of selectively brewing a batch of coffee on demand and selectively dispensing coffee into containers on demand comprising a coffee brewing station to brew and store the brewed coffee, a remote coffee dispensing station to dispense brewed coffee received from said brewing station, a circulation system to circulate brewed coffee between said coffee brewing station and said coffee dispensing station and a system control processor to control the brewing, circulating and dispensing of the coffee by said automated coffee brewing and dispensing apparatus.
